(19) United States
(12) Patent Application Publication
(10) Pub. No.: US 2018/0191685 A1
(43) Pub. Date: Jul. 5, 2018

(54) RECURRING TRANSFER NOTIFICATIONS AND SECURE TRANSFERS

(71) Applicant: The Western Union Company, Englewood, CO (US)

(72) Inventor: Anand Bajoria, San Jose, CA (US)

(73) Assignee: The Western Union Company, Englewood, CO (US)

(21) Appl. No.: 15/396,433

(22) Filed: Dec. 31, 2016

(51) Int. Cl. H04L 29/06; G06F 17/30; G06Q 20/14; H04L 12/58; H04L 29/08

(52) U.S. Cl. CPC H04L 63/04; H04L 63/0861; H04L 67/10; G06Q 20/145; H04L 51/24; G06F 17/30368

(57) ABSTRACT

Requests for secure transfers may be received and processed between devices at different domains within electronic transfer networks. Various properties and recurrence parameters may be received and stored based on a first secure transfer request initiated at a transferor device. At future recurrence notification times, a secure transfer server may generate customized notifications to request/initiate a recurring transfer based on the first secure transfer request. Customized notifications may include the properties associated with the first secure transfer request, and may be customized based on a particular transferor device. Customized recurrence notifications may further include data objects configured to invoke a process within the secure transfer server to initiate secure transfers. Further, the secure transfer server may automatically detect changes in relevant transfer parameters and properties between recurring transfer requests, in order to customize current instances of recurring transfer notifications.

### BACKGROUND

### Field of the Invention

The present invention relates generally to receiving and handling secure transfers between devices at different locations or domains within electronic transfer networks.

### Description of the Related Art

Within electronic data transfer networks, one or more central transfer servers along with various intermediary computing infrastructure and communication networks may be used to initiate and perform secure transfers between sender devices and receiver devices. In some cases, sender devices and receiver devices for a requested transfer may operate at separate locations or domains with a larger transfer system, and thus may have different networks and different subsets of available resources may be available to the different devices within the requested transaction. Central transfer servers and other computing systems may determine and assign resources for performing requested transfers, for example, by evaluating credentials of senders and the sender devices initiating the requested transfers.

### SUMMARY

Certain embodiments of the present disclosure relate generally to systems and methods of data storage, and more particularly to systems and methods for layering file system functionality on an object interface.

Various techniques are described herein for receiving and handling secure transfers between devices at different locations or domains within electronic transfer networks. In some embodiments, one or more secure transfer servers (e.g., within a secure transfer system) may receive and store properties associated with a first secure transfer request initiated by a user at a transferor device. The secure transfer servers also may receive and store recurrence parameters associated with the first secure transfer request, and may determine future recurrence notification times based on the recurrence parameters. At a time based on the future recurrence notification time, for example, at or shortly before the determined recurrence time, the secure transfer servers may retrieve the properties associated with the first secure transfer request, and generate a customized notification allowing the user to request/initiate a recurring transfer similar or identical to the first secure transfer request. In some embodiments, the customized notification may include the plurality of properties associated with the first secure transfer request, and/or may be customized based on the particular transferor device or another transferor device associated with the user. Further, the notification may include a data object configured to invoke a process within the secure transfer server to initiate secure transfers, thereby allowing the user to request/initiate a recurring transfer based on the first secure transfer request.

Certain additional techniques discussed herein relate to automatically detecting changes in certain relevant transfer parameters and properties between recurring transfer requests, in order to customize a current instance of a notification to initiate a recurring transfer. For example, changes in transferor and/or transferee locations, as well as changes in fees, exchange rates, transfer protocols and regulations, and the like, may necessitate additional review or confirmation before a subsequent recurring transfer may be performed. Further, in some embodiments, the notification of the recurring transfer transmitted to the transferor device may cause the transferor device to invoke a mobile application, access a web-based resource, or the like, and further may cause the transferor device to initiate biometric input components to validate the identity of the user before performing the recurring transfer.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

FIG. 1 is a block diagram illustrating an example of an electronic data transfer network, according to one or more embodiments of the disclosure.

FIG. 2 is a block diagram illustrating various components and features of an example transaction client device, according to one or more embodiments of the disclosure.

FIG. 3 is a block diagram illustrating a computer server and computing environment within an electronic data transfer network, according to one or more embodiments of the disclosure.

FIG. 4 is a block diagram illustrating an embodiment of one or more data store servers within an electronic data transfer network, according to one or more embodiments of the disclosure.

FIG. 5 is a block diagram illustrating an embodiment of one or more content management servers within an electronic data transfer network, according to one or more embodiments of the disclosure.

FIG. 6 is a block diagram illustrating the physical and logical components of a special-purpose computing device within an electronic data transfer network, according to one or more embodiments of the disclosure.

FIG. 7 is a block diagram illustrating an example transfer system computing environment including sender and receiver devices, and a secure transfer system, according to one or more embodiments of the disclosure.

FIG. 8 is a flow diagram illustrating an example process of determining and storing data defining a recurring transfer, according to one or more embodiments of the disclosure.

FIGS. 9A and 9B are illustrative display screens of an example user interface for defining a recurring transfer, according to one or more embodiments of the disclosure.

FIG. 10 is a flow diagram illustrating an example process of transmitting a recurring transfer notification and initiating a recurring transfer, according to one or more embodiments of the disclosure.

FIG. 11 is an illustrative display screen showing an example recurring transfer notification, according to one or more embodiments of the disclosure.

It is noted that any of the elements and/or steps provided in the block diagrams, flow diagrams, method diagrams, and other illustrations of the figures may be optional, replaced, and/or include additional components, such as combined and/or replaced with other elements and/or steps from other figures and text provided herein. Various embodiments of the present invention are discussed below, and various combinations or modifications thereof may be contemplated.

### DETAILED DESCRIPTION

The ensuing description provides illustrative embodiment(s) only and is not intended to limit the scope, applicability or configuration of the disclosure. Rather, the ensuing description of the illustrative embodiment(s) will provide those skilled in the art with an enabling description for implementing a preferred exemplary embodiment. It is understood that various changes can be made in the function and arrangement of elements without departing from the spirit and scope as set forth in the appended claims.

Various techniques (e.g., systems, methods, computer-program products tangibly embodied in a non-transitory machine-readable storage medium, etc.) are described herein for receiving and handling secure transfers between devices at different locations or domains within electronic transfer networks. In some embodiments, one or more secure transfer servers (e.g., within a secure transfer system) may receive and store properties associated with a first secure transfer request initiated by a user at a transferor device. The secure transfer servers also may receive and store recurrence parameters associated with the first secure transfer request, and may determine future recurrence notification times based on the recurrence parameters. At a time based on the future recurrence notification time, for example, at or shortly before the determined recurrence time, the secure transfer servers may retrieve the properties associated with the first secure transfer request, and generate a customized notification allowing the user to request/initiate a recurring transfer similar or identical to the first secure transfer request. In some embodiments, the customized notification may include the plurality of properties associated with the first secure transfer request, and/or may be customized based on the particular transferor device or another transferor device associated with the user. Further, the notification may include a data object configured to invoke a process within the secure transfer server to initiate secure transfers, thereby allowing the user to request/initiate a recurring transfer based on the first secure transfer request.

Certain additional techniques discussed herein relate to automatically detecting changes in certain relevant transfer parameters and properties between recurring transfer requests, in order to customize a current instance of a notification to initiate a recurring transfer. For example, changes in transferor and/or transferee locations, as well as changes in fees, exchange rates, transfer protocols and regulations, and the like, may necessitate additional review or confirmation before a subsequent recurring transfer may be performed. Further, in some embodiments, the notification of the recurring transfer transmitted to the transferor device may cause the transferor device to invoke a mobile application, access a web-based resource, or the like, and further may cause the transferor device to initiate biometric input components to validate the identity of the user before performing the recurring transfer.

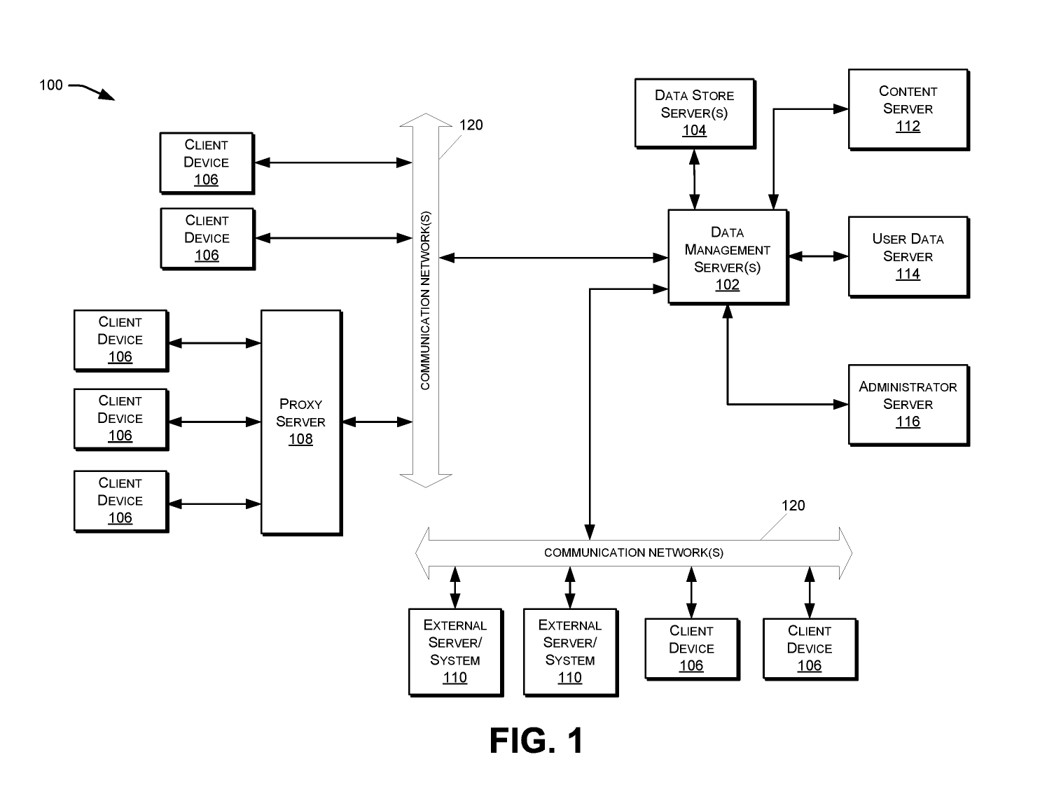

With reference now to FIG. 1, a block diagram is shown illustrating various components of an electronic transfer network 100 which implements and supports certain embodiments and features described herein. As discussed below in more detail, various embodiments of electronic transfer networks 100 may be implemented and configured to perform secure transfers between client devices 106, systems servers (e.g., 102), and/or external systems 110. In some embodiments, the various computing devices and systems shown in FIG. 1 may correspond to different physical or virtual domains/regions, for instance, different geographic areas within different jurisdictions, different data centers, different networks, different computing infrastructures, etc. As described herein, secure transfers may include transfers of various different types of data items (e.g., files, database records, media or other content resources, etc.), as well as other secure data transactions or other interactions between a sender and receiver devices/servers. In some embodiments, the electronic transfer network 100 may be configured to operate as a value transfer system by which users at client devices 106 may initiate value transfers to users at other client devices 106. In such cases, management servers 102 and/or external systems 110 may correspond to secure systems operated by financial institutions or other entities, by which sender and receiver credentials and value transfer requests may be received and analyzed, and value-based transactions may be authorized and performed.

Thus, in various embodiments, electronic transfer network 100 may be configured to support and perform transfers of various currency types, including traditional and/or digital currencies, centralized and/or de-centralized currencies, cryptocurrencies, and any other medium of exchange (e.g., credit, gift cards or certificates, points in a user point system, etc.), between client devices 106 and/or external systems 110 in different areas, regions, or jurisdictions. In other embodiments, the electronic transfer network 100 may be configured to perform other types of multi-party data transfers and/or secure transactions, such as transfers of data items including secure files, records, and/or content resources, between client devices 106 and other client devices 106, management servers 102 and/or external systems 110. For such transfers, the endpoint systems may be operating in the same location, using the same communication networks 120, and/or using the same computing hardware and software infrastructure, or may operate in different locations, on different networks, and/or in different datacenters, etc. Data management servers 102 and related servers (e.g., 104, 108, 112, 114, 116, etc.) in some embodiments, may correspond to authentication systems, data access/permission systems, subscription monitor systems, network access providers, and/or any other servers that may be used to monitor, permit/deny access, and/or enable data transfers. In still other embodiments, network 100 may be implemented as part of interactive gaming systems, educational and profession training systems, and/or social network systems, to enable the transfer of certain data or values (e.g., points, credits, resources, etc.) between users on different systems and/or in different locations.

As shown in FIG. 1, electronic transfer network 100 may include one or more data management servers 102. Data management servers 102 may be any desired type of server including, for example, a rack server, a tower server, a miniature server, a blade server, a mini rack server, a mobile server, an ultra-dense server, a super server, or the like, and may include various hardware components, for example, a motherboard, a processing units, memory systems, hard drives, network interfaces, power supplies, etc. Data management servers 102 may include one or more server farms, clusters, or any other appropriate arrangement and/or combination or computer servers. Data management servers 102 may act according to stored instructions located in a memory subsystem of the servers 102, and may run an operating system, including any commercially available server operating system and/or any other operating systems discussed herein.

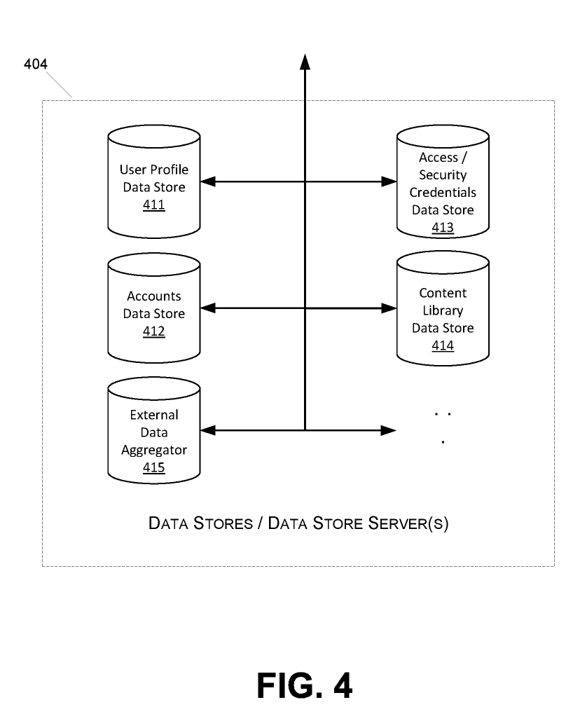

The electronic transfer network 100 may include one or more data store servers 104, such as database servers and file-based storage systems. Data stores 104 may comprise stored data relevant to the functions of the electronic transfer network 100. Illustrative examples of data stores 104 that may be maintained in certain embodiments of the electronic transfer network 100 are described below in reference to FIG. 4. In some embodiments, multiple data stores may reside on a single server 104, either using the same storage components of server 104 or using different physical storage components to assure data security and integrity between data stores. In other embodiments, each data store may have a separate dedicated data store server 104.

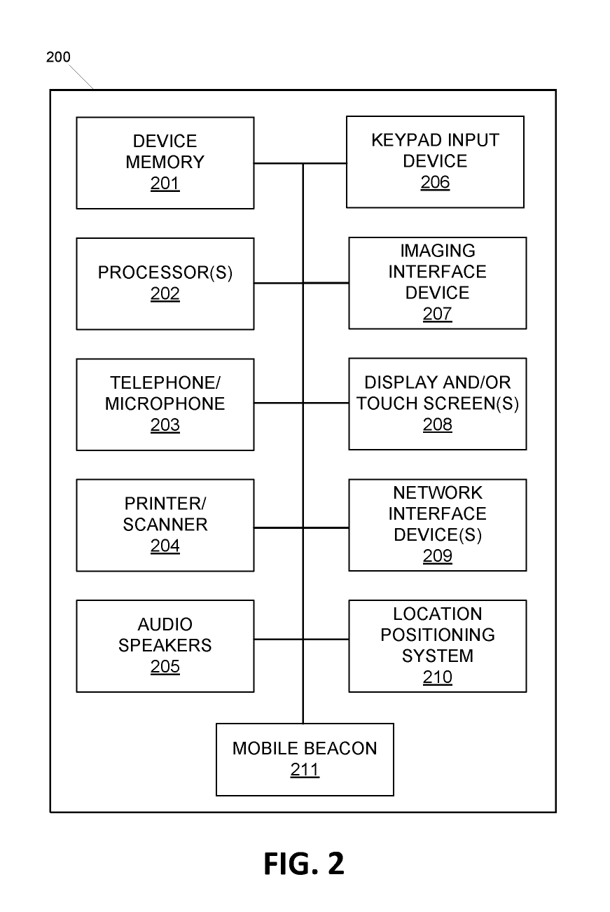

Electronic transfer network 100 also may include one or more client devices 106. Client devices 106 may display data received via the electronic transfer network 100, and may support various types of user interactions with the data. Client devices 106 may include mobile devices such as smartphones, tablet computers, personal digital assistants, and wearable computing devices. Such mobile devices may run a variety of mobile operating systems, and may be enabled for Internet, e-mail, short message service (SMS), Bluetooth®, mobile radio-frequency identification (M-RFID), and/or other communication protocols. Other client devices 106 may be general purpose personal computers or special-purpose computing devices including, by way of example, personal computers, laptop computers, workstation computers, projection devices, and interactive room display systems. Additionally, client devices 106 may be any other electronic devices, such as thin-client computers, Internet-enabled gaming systems, business or home appliances, and/or personal messaging devices, capable of communicating over network(s) 120. In some embodiments, one or more client devices 106 may include digital kiosk devices such as point-of-sale terminals, value transfer terminals, and/or digital advertising or display devices, including some or all of the features described below in reference to FIG. 2.

In different contexts of electronic transfer networks 100, client devices 106 may correspond to different types of specialized devices, for example, employee devices and presentation devices in a company network, gaming devices in a gaming network, networked point-of-sale terminals or digital advertising terminals in a retail network, etc. In some embodiments, client devices 106 may operate in the same physical location, such as the conference room or same retail store location. In such cases, the devices 106 may contain components that support direct communications with other nearby devices 106, such as a wireless transceivers and wireless communications interfaces, Ethernet sockets or other Local Area Network (LAN) interfaces, etc. In other implementations, the client devices 106 need not be used at the same physical location, but may be used in remote geographic locations in which each client device 106 may use security features and/or specialized hardware (e.g., hardware-accelerated SSL and HTTPS, WS-Security, firewalls, etc.) to communicate with the data management server 102 and/or other remotely located client devices 106. Additionally, different client devices 106 may be assigned different designated roles, such as sender devices, receiver devices, administrator devices, or the like, and in such cases the different devices may be provided with additional hardware and/or software components to provide content and support user capabilities not available to the other devices.

The electronic transfer network 100 also may include one or more proxy servers 108 configured to operate between a set of related client devices 106 and the back-end server(s) 102. In some cases, proxy server 108 may maintain private user information for client devices 106 interacting with applications or services hosted on other servers. For example, the proxy server 108 may be used to maintain private data of a user within one jurisdiction even though the user is accessing an application hosted on a server (e.g., the data management server 102) located outside the jurisdiction. In such cases, the proxy server 108 may intercept communications between multiple different client devices 106 and/or other devices that may include private user information. The proxy server 108 may create a token or identifier that does not disclose the private information and may use the token or identifier when communicating with the other servers and systems, instead of using the user's private information.

The electronic transfer network 100 also may include one or more external servers/systems 110 configured to connect to the back-end server(s) 102 through various communication networks 120 and/or through proxy servers 108. External servers/systems 110 may include some or all of the same physical and logical components as the data management server(s) 102, and may be configured to provide various data sources and/or services to the other components of the electronic transfer network 100.

As illustrated in FIG. 1, the data management server 102 may be in communication with one or more additional servers, such as a content server 112, a user data server 112, and/or an administrator server 116. Each of these servers may include some or all of the same physical and logical components as the data management server(s) 102, and in some cases, the hardware and software components of these servers 112-116 may be incorporated into the data management server(s) 102, rather than being implemented as separate computer servers.

Content server 112 may include hardware and software components to generate, store, and maintain the content resources for distribution to client devices 106 and other devices in the network 100. For example, in electronic transfer networks 100 used for professional training and educational purposes, content server 112 may include data stores of training materials, presentations, interactive programs and simulations, and various training interfaces that correspond to different materials and/or different types of user devices 106. In content electronic transfer networks 100 used for distribution of media content, advertising, and the like, a content server 112 may include media and advertising content files.

User data server 114 may include hardware and software components that store and process data for multiple users relating to each user's activities and usage of the electronic transfer network 100. For example, the data management server 102 may record and track each user's system usage, including their client device 106, data accessed and transferred, and interactions with other client devices 106. This data may be stored and processed by the user data server 114, to support user tracking and analysis features. For instance, in business training contexts, the user data server 114 may store and analyze each user's training materials viewed, courses completed, interactions, and the like. In the context of advertising, media distribution, and interactive gaming, the user data server 114 may store and process resource access data for multiple users (e.g., transactions initiated, sent, and received, data files accessed, access times, data usage amounts, user histories, user devices and device types, etc.).

Administrator server 116 may include hardware and software components to initiate various administrative functions at the data management server 102 and other components within the content distribution network 100. For example, the administrator server 116 may monitor device status and performance for the various servers, data stores, and/or client devices 106 in the electronic transfer network 100. When necessary, the administrator server 116 may add or remove devices from the network 100, and perform device maintenance such as providing software updates to the devices in the network 100. Various administrative tools on the administrator server 116 may allow authorized users to set user access permissions to various data resources, monitor resource usage by users and devices 106, and perform analyses and generate reports on specific network users and/or devices (e.g., resource usage tracking reports, training evaluations, etc.).

The electronic transfer network 100 may include one or more communication networks 120. Although two networks 120 are identified in FIG. 1, the electronic transfer network 100 may include any number of different communication networks between any of the computer servers and devices shown in FIG. 1 and/or other devices described herein. Communication networks 120 may enable communication between the various computing devices, servers, and other components of the electronic transfer network 100. As discussed below, various implementations of electronic transfer networks 100 may employ different types of networks 120, for example, computer networks, telecommunications networks, wireless networks, and/or any combination of these and/or other networks.

As noted above, in certain embodiments, electronic transfer network 100 may be a cryptocurrency network or other network using encryption protocols and techniques for performing transfers of cryptocurrency and/or other alternative digital currencies. Illustrative and non-limiting examples of such cryptocurrency networks may include a bitcoin peer-to-peer (P2P) payment network, a Litecoin network, a Peercoin network, and various other private digital cryptocurrency networks. The various computing devices and servers in such cryptocurrency networks 100, including client devices 106, management servers 102, and/or external systems 110, may be configured to perform cryptocurrency transfers as senders and/or receivers. For example, a client device 106 may securely store a private cryptographic key associated with a cryptocurrency account of a user, and may use specialized client software (e.g., cryptocurrency wallet application) to generate digital cryptographic signatures using the private cryptographic key and data identifying the details of the requested cryptocurrency transfer. In some cases, the cryptocurrency client application may execute a cryptographic hash function to generate a hash value signature based on the private key value associated with the cryptocurrency account. Recipient client devices 106, as well as other servers/systems in the network 100, may use the public key of the sender to decrypt the cryptographic signature and verify the authenticity of the requested cryptocurrency transfer. Some or all of the client devices 106, servers 102, and/or external systems 110 may use databases or other secure storage to independently maintain and update electronic ledgers for tracking the current balances associated with cryptocurrency accounts.

In some embodiments, certain computing devices and servers in a cryptocurrency network 100 may function as miner systems that are configured to perform complex mathematical operations in order to produce new cryptocurrency. Thus, various client devices 106, servers 102, and/or external systems 110 may be implemented as cryptocurrency miners. In some cases, these devices/systems may include specialized hardware and software designed for cryptocurrency mining, such as application-specific integrated circuits (ASICs) that are specifically designed and configured for cryptocurrency mining and/or specialized cryptocurrency mining software. In some cases, specialized cryptocurrency mining software may be used to allow collaboration between multiple different devices/systems which may function as a mining pool.

In some embodiments, various computing devices and servers in a cryptocurrency network 100 may be configured to collaboratively generate and store universal public ledgers and/or transaction chains for the cryptocurrency network 100. For example, computing devices and systems within the cryptocurrency network 100 may be configured to retrieve individual cryptocurrency transactions from a pool and resolve the transactions by solving associated mathematical problems, such as cryptographic hashes. After the problem is solved, the associated cryptocurrency transaction may be added to a universal transaction chain which is shared by other devices and systems of the cryptocurrency network 100. Each device/system in the cryptocurrency network 100 may independent maintain a copy of the transaction chain, and may periodically (or upon request from other systems) share their copy of the transaction chain in order to synchronize and reconcile different versions.

In some embodiments, a transaction chain for a cryptocurrency system/network may be stored in a distributed database by multiple different data nodes at different devices/servers within the network 100. For example, blockchain technology may be used to implement a decentralized distributed database which may be hosted by a combination of client devices 106, data management servers 102, and/or external systems 110. The blockchain (or other decentralized storage system) may store a distributed electronic ledger and/or universal transaction chain for the cryptocurrency network 100. The blockchain may be accessed by individual client software (e.g., wallet applications) of client devices 106, which may propose a cryptocurrency value transfer to be added to the blockchain. After analyzing and authorizing the requested transfer (e.g., by confirming that there is sufficient cryptocurrency value in the sender's account), a miner node within the cryptocurrency network 100 may bundle the transfer with other transactions to create a new block to be added to the blockchain. In some cases, adding blocks to the blockchain may involve miner nodes repeatedly executing cryptographic hash functions, ensuring that the blockchain cannot be tampered with by any malicious systems within the network 100.

As noted above, the client devices 106 in the electronic transfer network 100 may include various mobile devices, such as smartphones, tablet computers, personal digital assistants, wearable computing devices, bodily implanted communication devices, vehicle-based devices, etc. Within an electronic transfer network 100, mobile devices 106 may be configured to support mobile payment and/or mobile money transfer functionality. Such mobile devices 106 may initiate and receive communications via the Internet, e-mail, short message service (SMS), Bluetooth®, mobile radio-frequency identification (M-RFID), near-field communication (NFC) and/or various other communication protocols. In some cases, mobile devices 106 may execute a mobile wallet application to store user data and support secure data and/or value transfers via various different techniques, for example, SMS-based transactional payments, direct mobile billing, Web Application Protocol mobile payments, and NFC-based payments.

In some examples, the electronic transfer network 100 shown in FIG. 1 may correspond to an interactive user platform, such as a social networking platform, messaging platform, and/or gaming platform. In such cases, an electronic transfer technology platform may be integrated within the social networking, messaging and/or gaming platform 100, in order to provide interactive users with the capabilities to perform quick and convenient value transfers with other users anywhere in the world. Such embodiments may apply to various different collaborative user platforms and applications, including social media applications, email applications, chat and messaging applications, online gaming applications, and the like. These applications may be executed on client devices 106 and may transmit communications to and/or establish communication sessions with corresponding applications on other client devices 106 and/or external systems 110. In some embodiments, the secure data and/or value transfer capabilities of one or more transfer services providers may be embedded into various collaborative user platforms. For example, from within a social networking or messaging application running on client device 106, a user may be able to request and fund value transfers utilizing a debit card, credit card, or bank account, and easily direct the funds to another user on the same collaborative platform, or to retail agent location and/or to a mobile wallet or bank account. Integration of secure value transfer technologies within social networking applications, messaging applications, and the like, may provide a cross-border platform for transfer services that enables pay-in and pay-out capabilities that leverage technology, foreign exchange conversion, data management, as well as regulatory, compliance and anti-money laundering (AML) infrastructure of the transfer service provider, to expedite efficient and timely transfers. In such cases, the technology platform used to support secure data and/or value transfers within the network 100 may be accessible to messaging, social, and other digital networks, and may offer a suite of APIs built on a highly scalable infrastructure, enabling fast deployment of domestic and cross-border remittance capabilities.

Referring now to FIG. 2, a simplified block diagram is illustrating showing a digital kiosk device 206. In some embodiments, digital kiosk devices 206 may be another example of client devices 106. The digital kiosk device 206 may be implemented, for example, as a kiosk in a retail store, a value transfer terminal for performing value transfers (e.g., transfers of money and other assets, submitting payments to payees, etc.), a point-of-sale terminal, an electronic advertising system, and/or other various electronic display systems. The digital kiosk device 206 may be operated by a user (e.g., customer, shopper), and/or by agent, employee, or representative of a business providing or operating the kiosk 206. In various embodiments, the digital kiosk device 206 may include one or more of: a memory system 210, a processing unit 211, a telephone/microphone I/O component system 212, a printer/scanner I/O component system 213, an audio speaker system 214, a keypad input device 215, an imaging interface device 216, one or more digital display screens 217, one or more network interface devices 218 (e.g., network interface controllers, RF transceivers, etc.), and a digital positioning system 219 (e.g., Global Positioning System (GPS) receiver device). In various embodiments, digital kiosk devices 206 may include a touch screen that functions as the display screen 217 and/or the keypad 215. The keypad 215 may instead be any device that accepts user input, such as a trackball, mouse, or joystick. The imaging interface device 216 may serve to allow the digital kiosk device 206 to communicate with an imaging device. Alternatively, an imaging device may be directly incorporated into the digital kiosk device 206. Speakers 214 may be any audio output device. The printer 213 may be used to provide the user a receipt, point-of-sale information (e.g., product information, order confirmation, etc.), coupon, advertisement, or other information to be taken with the user, and scanner 213 may be used to scan a QR Code or barcode identifying a user or transaction, transfer request, user identification card, coupon, or the like. In some embodiments, a telephone/microphone 212 may be used in conjunction with speakers 214 to interact with the digital kiosk device 206, or a remotely located user (e.g., counterpart user in a transaction, customer representative, etc.) when performing a transfer or requesting information. Digital kiosk devices 206 may include various different types of digital position systems 219 (or geo-location systems 219), such as a Global Positioning System (GPS) receiver, so that kiosk location data may be collected and returned to data management servers 102 and/or other client devices 106. In some cases, such kiosk location data may be used to determine which content a specific digital kiosk device 206 is permitted to receive (e.g., based on domain/jurisdiction), and also may be used to determine factors such as language, data availability, network availability, product availability, and the like.

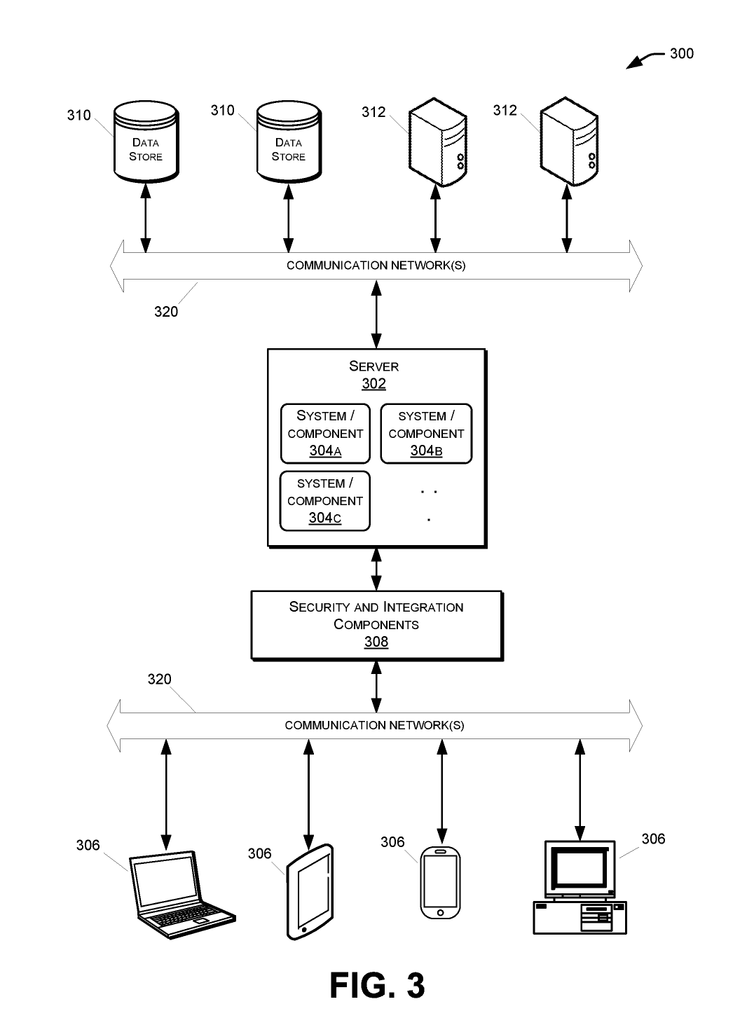

With reference to FIG. 3, an illustrative distributed computing environment 300 is shown including a computer server 302, four client computing devices 306, and other components that may implement certain embodiments and features described herein. In some embodiments, the server 302 may correspond to the data management server 102 discussed above in FIG. 1, and the client computing devices 306 may correspond to the client devices 106 and/or 206. However, the computing environment 300 illustrated in FIG. 3 also may correspond to any other combination of devices and servers configured to implement a client-server model or other distributed computing architecture.

Client devices 306 may be configured to receive and execute client applications over one or more networks 320. Such client applications may be web browser based applications and/or standalone software applications, such as mobile device applications. Server 302 may be communicatively coupled with the client devices 306 via one or more communication networks 220. Client devices 306 may receive client applications from server 302 or from other application providers (e.g., public or private application stores). Server 302 may be configured to run one or more server software applications or services, for example, web-based or cloud-based services, to support content distribution and interaction with client devices 306. Users operating client devices 306 may in turn utilize one or more client applications (e.g., virtual client applications) to interact with server 302 to utilize the services provided by these components.

Various different subsystems and/or components 304 may be implemented on server 302. Users operating the client devices 306 may initiate one or more client applications to use services provided by these subsystems and components. The subsystems and components within the server 302 and client devices 306 may be implemented in hardware, firmware, software, or combinations thereof. Various different system configurations are possible in different distributed computing systems 300 and electronic transfer networks 100. The embodiment shown in FIG. 3 is thus one example of a distributed computing system and is not intended to be limiting.

Although exemplary computing environment 300 is shown with four client computing devices 306, any number of client computing devices may be supported. Such client 306 may include digital kiosk devices including some or all of the features described below in reference to FIG. 2. Other devices, such as specialized sensor devices, etc., may interact with client devices 306 and/or server 302.

As shown in FIG. 3, various security and integration components 308 may be used to send and manage communications between the server 302 and user devices 306 over one or more communication networks 320. The security and integration components 308 may include separate servers, such as web servers and/or authentication servers, and/or specialized networking components, such as firewalls, routers, gateways, load balancers, and the like. In some cases, the security and integration components 308 may correspond to a set of dedicated hardware and/or software operating at the same physical location and under the control of same entities as server 302. For example, components 308 may include one or more dedicated web servers and network hardware in a datacenter or a cloud infrastructure. In other examples, the security and integration components 308 may correspond to separate hardware and software components which may be operated at a separate physical location and/or by a separate entity.

Security and integration components 308 may implement various security features for data transmission and storage, such as authenticating users and restricting access to unknown or unauthorized users. In various implementations, security and integration components 308 may provide, for example, a file-based integration scheme or a service-based integration scheme for transmitting data between the various devices in the electronic transfer network 100. Security and integration components 308 also may use secure data transmission protocols and/or encryption for data transfers, for example, File Transfer Protocol (FTP), Secure File Transfer Protocol (SFTP), and/or Pretty Good Privacy (PGP) encryption.

In some embodiments, one or more web services may be implemented within the security and integration components 308 and/or elsewhere within the electronic transfer network 100. Such web services, including cross-domain and/or cross-platform web services, may be developed for enterprise use in accordance with various web service standards, such as RESTful web services (i.e., services based on the Representation State Transfer (REST) architectural style and constraints), and/or web services designed in accordance with the Web Service Interoperability (WS-I) guidelines. Some web services may use the Secure Sockets Layer (SSL) or Transport Layer Security (TLS) protocol to provide secure connections between the server 302 and client devices 306. SSL or TLS may use HTTP or HTTPS to provide authentication and confidentiality. In other examples, web services may be implemented using REST over HTTPS with the OAuth open standard for authentication, or using the WS-Security standard which provides for secure SOAP messages using XML encryption. In other examples, the security and integration components 308 may include specialized hardware for providing secure web services. For example, security and integration components 308 may include secure network appliances having built-in features such as hardware-accelerated SSL and HTTPS, WS-Security, and firewalls. Such specialized hardware may be installed and configured in front of any web servers, so that any external devices may communicate directly with the specialized hardware.

Communication network(s) 320 may be any type of network familiar to those skilled in the art that can support data communications using any of a variety of commercially-available protocols, including without limitation, TCP/IP (transmission control protocol/Internet protocol), SNA (systems network architecture), IPX (Internet packet exchange), Secure Sockets Layer (SSL) or Transport Layer Security (TLS) protocols, Hyper Text Transfer Protocol (HTTP) and Secure Hyper Text Transfer Protocol (HTTPS), Bluetooth®, Near Field Communication (NFC), and the like. Merely by way of example, network(s) 320 may be local area networks (LAN), such as one based on Ethernet, Token-Ring and/or the like. Network(s) 320 also may be wide-area networks, such as the Internet. Networks 320 may include telecommunication networks such as a public switched telephone networks (PSTNs), or virtual networks such as an intranet or an extranet. Infrared and wireless networks (e.g., using the Institute of Electrical and Electronics (IEEE) 802.11 protocol suite or other wireless protocols) also may be included in networks 320.

Computing environment 300 also may include one or more data stores 310 and/or back-end servers 312. In certain examples, the data stores 310 may correspond to data store server(s) 104 discussed above in FIG. 1, and back-end servers 312 may correspond to the various back-end servers 110-116. Data stores 310 and servers 312 may reside in the same datacenter or may operate at a remote location from server 302. In some cases, one or more data stores 310 may reside on a non-transitory storage medium within the server 302. Other data stores 310 and back-end servers 312 may be remote from server 302 and configured to communicate with server 302 via one or more networks 320. In certain embodiments, data stores 310 and back-end servers 312 may reside in a storage-area network (SAN), or may use a storage-as-a-service (STaaS) architectural model.

With reference to FIG. 4, an illustrative set of data stores and/or data store servers is shown, corresponding to the data store servers 104 of the electronic transfer network 100 discussed above in FIG. 1. One or more individual data stores 411-415 may reside in storage on a single computer server 104 (or a single server farm or cluster) under the control of a single entity, or may reside on separate servers operated by different entities and/or at remote locations. In some embodiments, data stores 411-415 may be accessed by the data management server 102 and/or other devices and servers within the network 100 (e.g., client devices 106, external systems 110, administrator servers 116, etc.). Access to one or more of the data stores 411-415 may be limited or denied based on the processes, user credentials, and/or devices attempting to interact with the data store.

The paragraphs below describe examples of specific data stores that may be implemented within some embodiments of an electronic transfer network 100. It should be understood that the below descriptions of data stores 411-415, including their functionality and types of data stored therein, are illustrative and non-limiting. Data stores server architecture, design, and the execution of specific data stores 411-415 may depend on the context, size, and functional requirements of an electronic transfer network 100. For example, in a secure data transfer systems 100 used for professional training, separate databases or file-based storage systems may be implemented in data store server(s) 104 to store trainee and/or trainer data, training module data and content descriptions, training results, evaluation data, and the like. In contrast, in electronic transfer systems 100 used to provide electronic advertising or other content from content providers to client devices, separate data stores may be implemented in data stores server(s) 104 to store listings of available content and descriptions, content usage statistics, client device profiles, account data, network usage statistics, etc.

A user profile data store 411 may include information relating to the end users within the electronic transfer network 100. This information may include user characteristics such as the user names, access credentials (e.g., logins and passwords), user preferences, and information relating to any previous user interactions within the electronic transfer network 100 (e.g., requested data, provided data, system usage data/statistics, associated users, etc.).

An accounts data store 412 may generate and store account data for different users in various roles within the electronic transfer network 100. For example, accounts may be created in an accounts data store 412 for individual end users, administrator users, and external entities such as businesses, governmental or educational institutions. Account data may include account types, current account status, account characteristics, and any parameters, limits, restrictions associated with the accounts.

A content/security credential data store 413 may include access rights and security information for the electronic transfer network 100 and specific files/content resources. For example, the content/security credential data store 413 may include login information (e.g., user identifiers, logins, passwords, etc.) that can be verified during login attempts by users and/or client devices 106 to the network 100. The content/security credential data store 413 also may be used to store assigned user roles and/or user levels of access. For example, a user's access level may correspond to the sets of data and/or the client or server applications that the user is permitted to access. Certain users and/or client devices may be permitted or denied access to certain applications and resources based on their access level, subscription level, etc. Certain users and/or client devices 106 may have supervisory access over one or more end users accounts and/or other client devices 106, allowing the supervisor to access all or portions of the user's content access, activities, etc. Additionally, certain users and/or client devices 106 may have administrative access over some users and/or some applications in the electronic transfer network 100, allowing such users to add and remove user accounts, modify user access permissions, perform maintenance updates on software and servers, etc.

A content library data store 414 may include information describing the individual data items (or resources) available via the electronic transfer network 100. In some embodiments, the content data store 414 may include metadata, properties, and other characteristics associated with the data items stored in the content server 112. Such data may identify one or more aspects or attributes of the associated data items, for example, subject matter or access level of the content resources, license attributes of the data items (e.g., any limitations and/or restrictions on the licensable use and/or distribution of the data items), price attributes of the data items (e.g., a price and/or price structure for determining a payment amount for use or distribution of the data items), language and geographic associations with the data items, and the like. In some embodiments, the content data store 414 may be configured to allow updating of data item metadata or properties, and to allow the addition and/or removal of information relating to the data items. For example, item relationships may be implemented as graph structures, which may be stored in the content data store 414 or in an additional data store for use by selection algorithms along with the other metadata.

In addition to the illustrative data stores described above, data store server(s) 104 (e.g., database servers, file-based storage servers, etc.) may include one or more external data aggregators 415. External data aggregators 415 may include third-party data sources accessible to the electronic transfer network 100, but not maintained by the electronic transfer network 100. External data aggregators 415 may include any electronic information source relating to the users, data items, or applications of the electronic transfer network 100. For example, external data aggregators 415 may be third-party data stores containing demographic data, education related data, financial data, consumer sales data, health related data, and the like. Illustrative external data aggregators 415 may include, for example, social networking web servers, public records data stores, educational institution servers, business servers, consumer sales data stores, medical record data stores, etc. Data retrieved from various external data aggregators 415 may be used to verify and update user account information, suggest or select user content, and perform user and content evaluations. In some cases, external data aggregators 415 may correspond to external servers/systems 110.

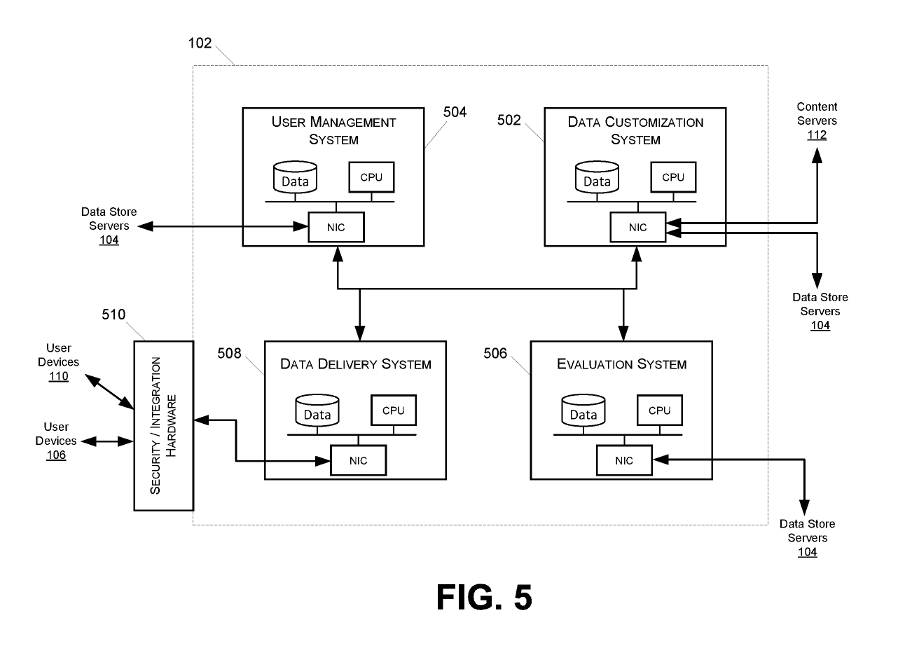

With reference now to FIG. 5, a block diagram is shown illustrating an embodiment of one or more data management servers 102 within an electronic transfer network 100. As discussed above, data management server(s) 102 may include various server hardware and software components that manage the content resources within the electronic transfer network 100 and provide interactive and adaptive content to users on various client devices 106. For example, data management server(s) 102 may provide instructions to and receive information from the other devices within the electronic transfer network 100, in order to manage and transmit data resources, user data, and server or client applications executing within the network 100.

A data management server 102 may include a data customization system 502. The data customization system 502 may be implemented using dedicated hardware within the electronic transfer network 100 (e.g., a data customization server 502), or using designated hardware and software resources within a shared data management server 102. In some embodiments, the data customization system 502 may adjust the selection and adaptive capabilities of data resources to match the needs and desires of the users and/or client devices 106 receiving the content. For example, the data customization system 502 may query various data stores and servers 104 to retrieve user information, such as user preferences and characteristics (e.g., from a user profile data store 411), location/geographic information associated with users and/or client devices 106, user access restrictions to data recourses (e.g., from an access credential data store 413), previous user activity within the network 100, and the like. Based on the retrieved information from data stores 104 and other data sources, the data customization system 502 may modify content resources for individual users and/or individual client devices 106.

A data management server 102 also may include a user management system 504. The user management system 504 may be implemented using dedicated hardware within the electronic transfer network 100 (e.g., a user management server 504), or using designated hardware and software resources within a shared data management server 102. In some embodiments, the user management system 504 may monitor the activities of users and/or user devices 106 with respect to various data resources. For example, the user management system 504 may query one or more databases and/or data store servers 104 to retrieve user data such as associated data resources, access and completion status, results, and the like.

A data management server 102 also may include an evaluation system 506. The evaluation system 506 may be implemented using dedicated hardware within the electronic transfer network 100 (e.g., an evaluation server 506), or using designated hardware and software resources within a shared data management server 102. The evaluation system 506 may be configured to receive and analyze information from client devices 106. For example, various data received by users via client devices 106 may be compiled and analyzed, and then stored in a data store 104 associated with the user and/or data item. In some embodiments, the evaluation server 506 may analyze the information to determine the effectiveness or appropriateness of data resources with a user or user group, for example, based on subject matter, age group, skill level, or the like. In some embodiments, the evaluation system 506 may provide updates to the data customization system 502 or the user management system 504, with the attributes of one or more data resources or groups of resources within the network 100.

A data management server 102 also may include a data delivery system 508. The data delivery system 508 may be implemented using dedicated hardware within the electronic transfer network 100 (e.g., a data delivery server 508), or using designated hardware and software resources within a shared data management server 102. The data delivery system 508 may receive data from the data customization system 502 and/or from the user management system 504, and transmit the resources to client devices 106. In some embodiments, the data delivery system 508 may determine the appropriate presentation format for the data resources based on the user characteristics and preferences, and/or the device capabilities of client devices 106. If needed, the data delivery system 508 may convert the content resources to the appropriate presentation format and/or compress the content before transmission. In some embodiments, the data delivery system 508 may also determine the appropriate transmission media and communication protocols for transmission of the data to and from client devices 106.

In some embodiments, the data delivery system 508 may include specialized security and integration hardware 510, along with corresponding software components to implement the appropriate security features for data transmission and storage, to provide the supported network and client access models, and to support the performance and scalability requirements of the network 100. The security and integration layer 510 may include some or all of the security and integration components 308 discussed above in FIG. 3, and may control the transmission of data, as well as the receipt of requests and data interactions, to and from the client devices 106, external servers 110, administrative servers 116, and other devices in the network 100.

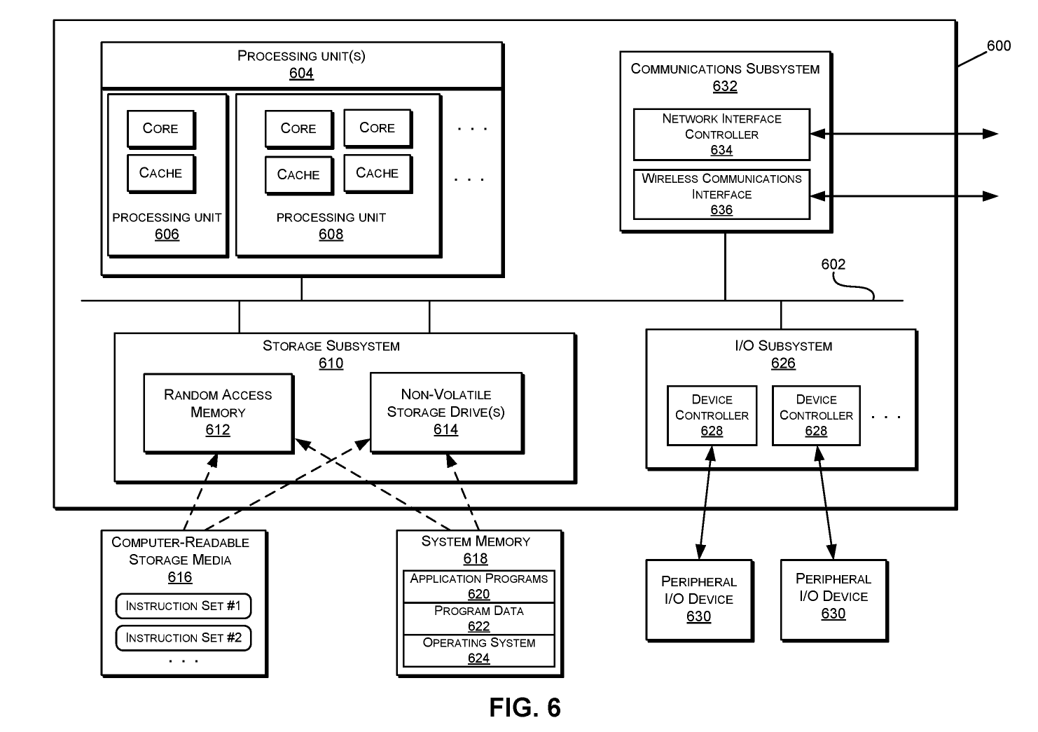

With reference now to FIG. 6, a block diagram of an illustrative computer system is shown. The system 600 may correspond to any of the computing devices or servers of the electronic transfer network 100 described above, or any other computing devices described herein. In this example, computer system 600 includes processing units 604 that communicate with a number of peripheral subsystems via a bus subsystem 602. These peripheral subsystems include, for example, a storage subsystem 610, an I/O subsystem 626, and a communications subsystem 632.

Bus subsystem 602 provides a mechanism for letting the various components and subsystems of computer system 600 communicate with each other as intended. Although bus subsystem 602 is shown schematically as a single bus, alternative embodiments of the bus subsystem may utilize multiple buses. Bus subsystem 602 may be any of several types of bus structures including a memory bus or memory controller, a peripheral bus, and a local bus using any of a variety of bus architectures. Such architectures may include, for example, an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 604, which may be implemented as one or more integrated circuits (e.g., a conventional microprocessor or microcontroller), controls the operation of computer system 600. One or more processors, including single core and/or multicore processors, may be included in processing unit 604. As shown in the figure, processing unit 604 may be implemented as one or more independent processing units 606 and/or 608 with single or multicore processors and processor caches included in each processing unit. In other embodiments, processing unit 604 may also be implemented as a quad-core processing unit or larger multicore designs (e.g., hexa-core processors, octo-core processors, ten-core processors, or greater. As discussed above, in some cases, processing unit 604 may include one or more specialized ASICs designed and configured for cryptocurrency mining and/or specialized cryptographic hardware for handling cryptocurrency transactions.

Processing unit 604 may execute a variety of software processes embodied in program code, and may maintain multiple concurrently executing programs or processes. At any given time, some or all of the program code to be executed can be resident in processor(s) 604 and/or in storage subsystem 610. In some embodiments, computer system 600 may include one or more specialized processors, such as digital signal processors (DSPs), outboard processors, graphics processors, application-specific processors, and/or the like.

I/O subsystem 626 may include device controllers 628 for one or more user interface input devices and/or user interface output devices 630. User interface input and output devices 630 may be integral with the computer system 600 (e.g., integrated audio/video systems, and/or touchscreen displays), or may be separate peripheral devices which are attachable/detachable from the computer system 600.

Input devices 630 may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. Input devices 630 may also include three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additional input devices 630 may include, for example, motion sensing and/or gesture recognition devices that enable users to control and interact with an input device through a natural user interface using gestures and spoken commands, eye gesture recognition devices that detect eye activity from users and transform the eye gestures as input into an input device, voice recognition sensing devices that enable users to interact with voice recognition systems through voice commands, medical imaging input devices, MIDI keyboards, digital musical instruments, and the like.

Output devices 630 may include one or more display subsystems, indicator lights, or non-visual displays such as audio output devices, etc. Display subsystems may include, for example, cathode ray tube (CRT) displays, flat-panel devices, such as those using a liquid crystal display (LCD) or plasma display, light-emitting diode (LED) displays, projection devices, touch screens, and the like. In general, use of the term “output device” is intended to include all possible types of devices and mechanisms for outputting information from computer system 600 to a user or other computer. For example, output devices 630 may include, without limitation, a variety of display devices that visually convey text, graphics and audio/video information such as monitors, printers, speakers, headphones, automotive navigation systems, plotters, voice output devices, and modems.

Computer system 600 may comprise one or more storage subsystems 610, comprising hardware and software components used for storing data and program instructions, such as system memory 618 and computer-readable storage media 616. The system memory 618 and/or computer-readable storage media 616 may store program instructions that are loadable and executable on processing units 604, as well as data generated during the execution of these programs.

Depending on the configuration and type of computer system 600, system memory 618 may be stored in volatile memory (such as random access memory (RAM) 612) and/or in non-volatile storage drives 614 (such as read-only memory (ROM), flash memory, etc.) The RAM 612 may contain data and/or program modules that are immediately accessible to and/or presently being operated and executed by processing units 604. In some implementations, system memory 618 may include multiple different types of memory, such as static random access memory (SRAM) or dynamic random access memory (DRAM). In some implementations, a basic input/output system (BIOS), containing the basic routines that help to transfer information between elements within computer system 600, such as during start-up, may typically be stored in the non-volatile storage drives 614. By way of example, and not limitation, system memory 618 may include application programs 620, such as client applications, Web browsers, mid-tier applications, server applications, etc., program data 622, and an operating system 624.

Storage subsystem 610 also may provide one or more tangible computer-readable storage media 616 for storing the basic programming and data constructs that provide the functionality of some embodiments. Software (programs, code modules, instructions) that when executed by a processor provide the functionality described herein may be stored in storage subsystem 610. These software modules or instructions may be executed by processing units 604. Storage subsystem 610 may also provide a repository for storing data used in accordance with the present invention.

Storage subsystem 610 also may include a computer-readable storage media reader that can further be connected to computer-readable storage media 616. Together and, optionally, in combination with system memory 618, computer-readable storage media 616 may comprehensively represent remote, local, fixed, and/or removable storage devices plus storage media for temporarily and/or more permanently containing, storing, transmitting, and retrieving computer-readable information.

Computer-readable storage media 616 containing program code, or portions of program code, may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computer system 600.

By way of example, computer-readable storage media 616 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 616 may include, but is not limited to, Zip® drives, flash memory cards, universal serial bus (USB) flash drives, secure digital (SD) cards, DVD disks, digital video tape, and the like. Computer-readable storage media 616 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 600.

Communications subsystem 632 may provide a communication interface from computer system 600 and external computing devices via one or more communication networks, including local area networks (LANs), wide area networks (WANs) (e.g., the Internet), and various wireless telecommunications networks. As illustrated in FIG. 6, the communications subsystem 632 may include, for example, one or more network interface controllers (NICs) 634, such as Ethernet cards, Asynchronous Transfer Mode NICs, Token Ring NICs, and the like, as well as one or more wireless communications interfaces 636, such as wireless network interface controllers (WNICs), wireless network adapters, and the like. Additionally and/or alternatively, the communications subsystem 632 may include one or more modems (telephone, satellite, cable, ISDN), synchronous or asynchronous digital subscriber line (DSL) units, FireWire® interfaces, USB® interfaces, and the like. Communications subsystem 636 also may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components.

The various physical components of the communications subsystem 632 may be detachable components coupled to the computer system 600 via a computer network, a FireWire® bus, or the like, and/or may be physically integrated onto a motherboard of the computer system 600. Communications subsystem 632 also may be implemented in whole or in part by software.

In some embodiments, communications subsystem 632 may also receive input communication in the form of structured and/or unstructured data feeds, event streams, event updates, and the like, on behalf of one or more users who may use or access computer system 600. For example, communications subsystem 632 may be configured to receive data feeds in real-time from users of social networks and/or other communication services, web feeds such as Rich Site Summary (RSS) feeds, and/or real-time updates from one or more third party information sources (e.g., data aggregators 309). Additionally, communications subsystem 632 may be configured to receive data in the form of continuous data streams, which may include event streams of real-time events and/or event updates (e.g., sensor data applications, financial tickers, network performance measuring tools, clickstream analysis tools, automobile traffic monitoring, etc.). Communications subsystem 632 may output such structured and/or unstructured data feeds, event streams, event updates, and the like to one or more data stores 104 that may be in communication with one or more streaming data source computers coupled to computer system 600.

Due to the ever-changing nature of computers and networks, the description of computer system 600 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

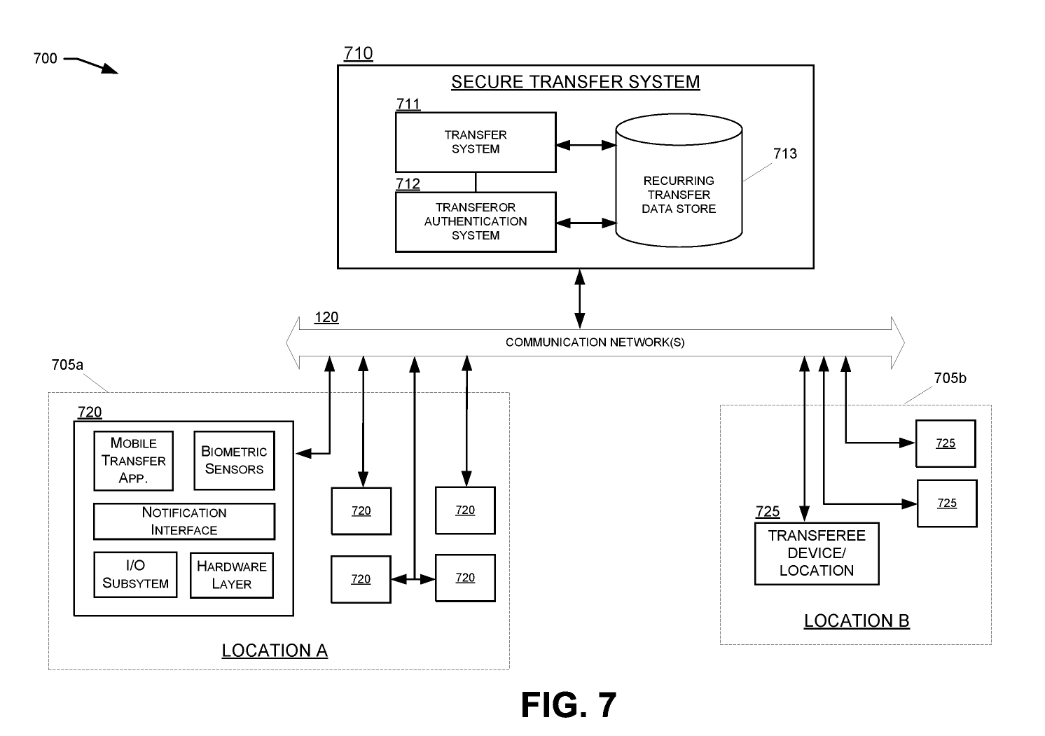

With reference now to FIG. 7, a block diagram is shown illustrating an example computing environment 700 configured to support secure transfers between sender devices 720 in one location 705a and receiver devices 725 in another location 705b. As shown in this example, certain embodiments may support transfers between locations 705a and 705b using a secure transfer system 710. In various embodiments, locations 705 may correspond to different physical or virtual domains/regions, for instance, different geographic areas within different jurisdictions, different data centers, different networks, different computing infrastructures, etc. As discussed in more detail below, a secure transfer system 710 may include various specialized software and/or hardware components, including a transfer system 711, a transferor authentication system 712, and a recurring transfer data store 713. Using such components, the secure transfer system 710 may be configured to store data defining a set of recurring transfers, including both the transfer details (e.g., transferor details, transferee details, amount and other transfer-specific details, etc.) along with associated recurrence parameters (e.g., recurrence schedule, recurrence conditions, etc.). Based on the recurring transfer data, the secure transfer system 710 may generate and transmit recurring transfer notifications to the appropriate transferor device(s) 720, which may be configured with its own various specialized software and/or hardware components to present recurring transfer notifications, and receive and transmit user input back to the secure transfer system 710. Such user responses may include confirmations of the recurring transfer, including user biometric data and/or other user authentication data. Additionally or alternatively, users may respond via a transferor device 725 to edit individual or recurring transfer details, before confirming (or not confirming) that the scheduled recurring transfer may be performed by the secure transfer system 710.

As described herein, transfers between a sender and receiver may refer to transfers of various different types of data items (e.g., files, database records, media or other content resources, etc.), as well as other secure data transactions or other interactions between a transferor (or sender) device 720 and a transferee (or receiver) device 725. In some embodiments, the computing environment 700 may be implemented as a value transfer system though which users at transferor devices 720 within a first location 705a may initiate value transfers to users at receiver devices 725 within a second location 705b. The secure transfer system 710 may be used in such embodiments to analyze value (e.g., financial asset) transfer provide requests transferor's credentials (e.g., credit score, risk assessment value, authorization limits, etc.), the transferee's credentials, and/or combinations of sender and receiver credentials, in order to enable immediate value transfers between value senders and receivers of the requested amount of a particular type of currency or other value. Different locations 705 may correspond to different geographic areas and/or different jurisdictions where different value transfer rules, regulations, fees, and exchange rates may apply. Thus, in such embodiments, computing environment 700 may be applied to applied to transfers of currency, or any other medium of exchange (e.g., credit, gift cards or certificates, points in a user point system, etc.), between users in different areas, regions, or jurisdictions (or to users within the same area/region/jurisdiction).

In other embodiments, the transfer system computing environment 700 may be configured to perform other types of multi-party data transfers and/or secure transactions, such as transfers of data items including secure files, records, and/or content resources, from a transferor device 720 in one location 705a to a receiver device 725 in another location 705b. In such embodiments, the locations 705a and 705b may correspond to different geographic areas and/or different computing infrastructures (e.g., different data centers, different networks, etc.) over which the secure electronic transfer may be performed. Transfer system(s) 711, in such embodiments, may correspond to authentication systems, data access/permission systems, subscription monitor systems, network access providers, and/or any other servers that may be used to monitor, permit/deny access, and/or enable data transfers. In still other implementations, computing environment 700 may be implemented as part of interactive gaming systems, educational and profession training systems, and/or social network systems, to enable the transfer of certain data or values (e.g., points, credits, resources, etc.) between system users in different locations 705.

As discussed in more below detail, transferor devices 720 and/or transferee devices 725 in various implementations may be configured to interact with users by receiving and outputting notifications of recurring transfers via I/O subsystems, and the receiving user input in response to such notifications corresponding to transfer requests, authentication credentials, and/or selections to revise an individual or recurring transfer. Transferor devices 720 and transferee devices 725 may interact with the secure transfer system 710 via one or more communication networks 120, and the computing infrastructures (e.g., access networks) available at their respective locations 705a and 705b. As discussed below, the secure transfer server 710 may, among other things, generate transmit notifications to a plurality of transferor devices 720, including initiating and/or a staging a transfer so that a user at a transferor device 720 need only confirm his or her identity (e.g., via biometric authentication) and reaffirm that the current instance of recurring transfer is to be performed.

In order to perform these features and other functionality described herein, each of the components and sub-components discussed in the example secure transfer system 710 may correspond to a single computer server or a complex computing system including a combination of computing devices, storage devices, network components, etc. Each of these components and their respective subcomponents may be implemented in hardware, software, or a combination thereof. Certain transferor devices 720 and transferee devices 725 may communicate directly with the secure transfer system 710, while other transferor and transferee devices 720-725 may communicate with the transfer system 710 indirectly via one or more intermediary network components (e.g., routers, gateways, firewalls, etc.) or other devices (e.g., data management servers 102, content servers 112, etc.). Although the physical network components have not been shown in this figure so as not to obscure the other elements depicted in the figure, it should be understood that any of the network hardware components and network architecture designs may be implemented in various embodiments to support communication between the servers and devices in the computing environment 700. Additionally, different user devices 720-725 may use different networks and networks types to communicate with the secure transfer system 710, including one or more telecommunications networks, cable networks, satellite networks, cellular networks and other wireless networks, and computer-based IP networks, and the like. Further, certain components within computing environment 700 may include special purpose hardware devices and/or special purpose software, such as those included in I/O subsystems systems, positioning systems, and storage and networking capabilities of the transferor and transferee devices 720 and 725, as well as those within the processing engines and data stores 711-713 of the secure transfer system 710.

In some embodiments, a transfer system computing environment 700 may be integrated within, or configured to operate in collaboration with, one or more electronic transfer networks 100. For example, computing environment 700 may be the same as, or may operate within or in collaboration with, any of the electronic transfer network 100 described above. Thus, specific examples of transfer system computing environments 700 may include, without limitation, secure systems for transferring value and other media of exchange, multi-entity systems for exchanging content resources (e.g., media files, educational and professional training content, gaming content, Internet content, etc.), and other electronic transfer systems. In such cases, the secure transfer system 710 may correspond to and may be implemented within a data management server 102 and/or a data store server 104, and transferor and transferee devices 720 and 725 may correspond to the client devices described above in reference to network 100. Thus, within computing environment 700, transferor and transferee devices 720 and 725 may request and receive data from the secure transfer system 710, may execute and/or display the data received data, and then may transmit various user responses/interaction data back the secure transfer system 710. In other examples, the secure transfer system 710 may be implemented using one or more computer servers, and other specialized hardware and software components, separately from other the components of an associated network 100, such as content servers 112, data management servers 102, data store servers 104, and the like. In these examples, the secure transfer system 710 may be configured to communicate directly with transferor and transferee devices 720 and 725 and/or external systems, or indirectly through data management servers 102 and/or other components and communications networks of the computing environment 700.

As noted above, the transferor devices 720 and transferee devices 725 in this example may include any of the types of client devices 106 discussed above. For example, the transferor devices 720 and/or transferee devices 725 may be laptop computers, smartphones, tablet computers, or various other type of mobile device, each of which may include some or all of the hardware, software, and networking components discussed above. Transferor devices 720 and/or transferee devices 725 also may be digital kiosk devices 206 including one or more of the additional components/features discussed above. Specifically, the transferor devices 720 and/or transferee devices 725 may be any computing device with sufficient memory, processing, and I/O subcomponents for initiating and/or presenting transfer requests from the client side. Accordingly, transferor devices 720 and/or transferee devices 725 may include the necessary hardware and software components to establish the network interfaces, security and authentication capabilities, and data caching capabilities to initiate and receive transfer requests, and receive and provide data to users in real-time or near real-time. Moreover, in certain embodiments, transferor devices 720 and/or transferee devices 725 may include digital positioning systems 219 (e.g., GPS receivers) or other location determination systems to detect and transmit device location data that may be used to determine the transfer properties applicable to their respective locations 705. In some cases, a certain transferor device 720 or transferee device 725 may change between locations 705a-705b over time, including changes in physical/geographic locations, as well as changes to its computing infrastructure (e.g., changes in network access or availability, changes in data centers or supporting hardware layers, etc.).

As discussed below in more detail, in some embodiments the transferor devices 720 and/or transferee devices 725 may include specialized user input hardware and software components for rapid and secure user authentication. For example, a transferor device 720 such as desktop computer, laptop computer, or mobile device may include biometric sensors such as a fingerprint sensor, microphone and voiceprint analyzer, a retinal scanner and/or iris scanner/recognition system, a camera and facial recognition software, a touch pad and signature analyzer, etc. In certain embodiments, as discussed below, the recurring transfer notification displayed via the transferor device may prompt a user to confirm the transfer and to provide one or more biometric inputs that may be transferred back to the secure transfer system 710 to authenticate the user's identity.

Although this example shows only two locations 705a and 705b and one central secure transfer system 710, it should be understood that any number of different locations 705 and transfer system instances 710 may be implemented in other examples. As discussed below, tracking and determining the locations 705 associated with transferors and transferees may be relevant for determining a particular set of properties or parameters for a transfer, such as value type (e.g., currencies), exchange rates, compliance with transfer regulations, fee determinations, etc. Thus, locations 705 may correspond to specific physical/geographic regions (e.g., countries, jurisdictions, physical domains, etc.), or to computing locations (e.g., specific data centers, networks, network domains, etc.). Locations 705 also may correspond to unique combinations of physical regions and “virtual regions” (e.g., specific computing infrastructures, networks, etc.). For instance, a location 705a may include all of the transferor and transferee devices 720 and 725, within a country (or other jurisdiction) that access the system 700 via a specified communication medium, network type, and/or client software application.

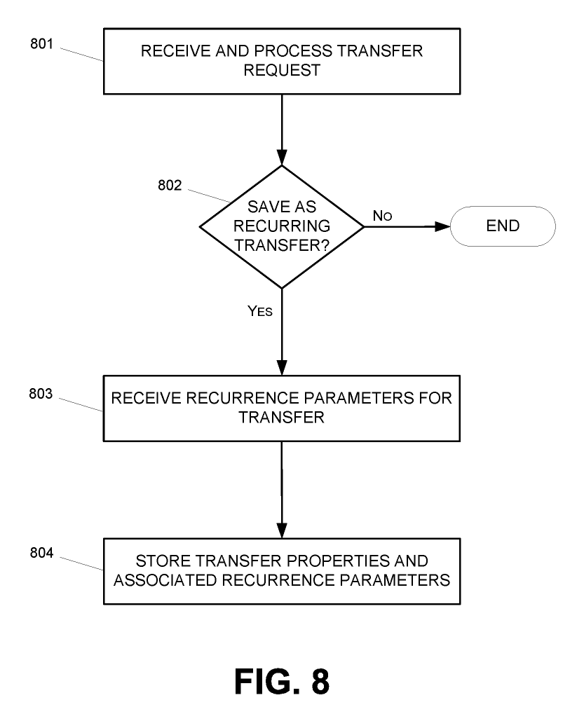

Referring now to FIG. 8, a flow diagram is shown illustrating an example process of determining and storing data defining recurring transfers. As described below, the steps in this process may be performed by one or more components in the transfer system computing environment 700 described above, such as the secure transfer system 710 in conjunction with a transferor device 720 (and/or transferee device 725). However, it should be understood that the various features and processes described herein, including processing transfer requests, generating and providing interfaces for defining transfer recurrence, and storing recurrence parameters associated with transfers, need not be limited to the specific systems and hardware implementations described above in FIGS. 1-7.

In step 801, the secure transfer system 710 may receive a process a transfer request in a manner typical for the particular computing environment 700. For example, as noted above, the computing environment 700 may be configured to operate as a value (or monetary) transfer system, by which users at transferor devices 720 may establish a secure communication session with the transfer system 710 to initiate value transfers to one or more different users at transferee devices 725 at various different locations 705. Thus, the transfer request processed in step 801 may correspond to a money transfer, retail purchase, or a transfer of any other medium of exchange. For such transfers, the defining characteristics/properties of the transfer may include data such as the sender's identity and information, the recipient's identity and information, and the specifics of the transfer (e.g., transfer amount, value/currency type, exchange rate, fees, funding sources, applicable terms and conditions, date and time of transfer initiation and completion, etc.).

User communicating with the secure transfer system 710 in step 801, through transferor device 720 and/or transferee devices 725, may use various different software components and network communication channels to request transfers, review/accept transfers, confirm transfers, view and save transfers, etc. For example, the transfer system 711 may provide a web-based interface accessible to web browser clients in the transferor and transferee devices 720 and 725 to perform the above functions. In other examples, mobile user device devices 720 and 725 may include a specialized mobile application configured to access the secure transfer system 710 to perform secure transfers. In still other embodiments, transferor and transferee devices 720 and 725 may correspond to specialized digital kiosk devices (e.g., 206) and/or agent terminals of associated with the secure transfer service.

In step 802, at any stage during or following the processing of the transfer request in step 801, the secure transfer system 710 may be configured to receive an indication from a user as to whether the transfer is to be saved for future recurring transfers. In some embodiments, the transferor may provide the indication upon completing/confirming the transaction, although in other embodiments the indication that the transfer is to be a recurring one may initiate with a request from the transferee when accepting the transfer (e.g., to be approved thereafter by the transferor).

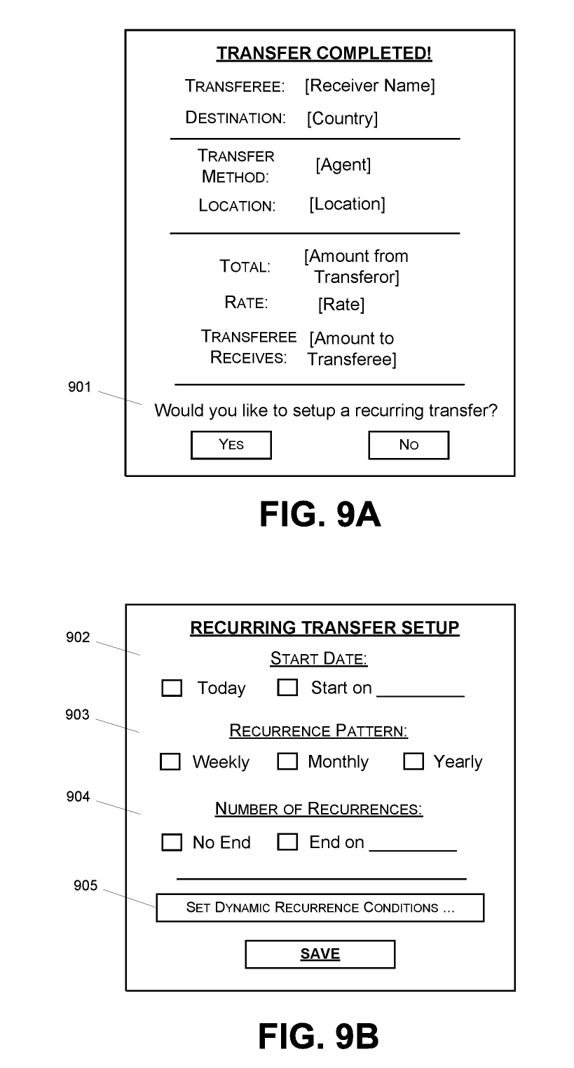

Referring briefly to FIG. 9A, an example user interface display screen is shown of a transfer confirmation screen, in which the user (e.g., a sender via a mobile transferor device 720) may be presented with an option 901 to save the recently completed as a recurring transfer. Thus, as discussed below in more detail, subsequent transfer instances of the recurring transfer would be automatically initiated having the same transfer properties, such as the same transferor, transferee, transfer destination, transfer method, pickup location, as well as the same transfer amount, exchange rate, and/or amount received by the transferee. Among other potential advantages discussed herein, defining recurring transfers may allow the transferor to perform a similar or identical subsequent transfer without having to input these transfer field and properties for the subsequent transfer.

In step 803, if the user (e.g., sender via a transferor device 720) has selected the transfer to be saved as a recurring transfer (802: Yes), then the secure transfer system 710 may transmit an additional user interface to the transferor device 720 in order to receive the specific recurrence parameters to define the scheduling and conditions associated with the recurring transfer. For example, recurrence parameters may define when, how often, for how long, and/or under what conditions the recurring transfer should be subsequently performed.

Referring briefly to FIG. 9B, another example user interface display screen is shown including components to allow a user (e.g., a transferor and/or transferee) to define the recurrence parameters for a selected transfer. As in this example, the secure transfer system 710 may use the interface to prompt the user to select a recurrence start date 902, a recurrence pattern 903 (e.g., which may include a day of the week, or date of the month or year on which the subsequent transfers should be performed), and a length of the transfer recurrence (e.g., which may be expressed by a total number of subsequent recurring transactions to be performed and/or by the selection of an end date), etc.

Additionally, this example includes an additional component 905 to allow the user to define one or more additional dynamic recurrence conditions. In some embodiments, the dynamic recurrence conditions defined via button 905 may override the recurrence parameters defined in sections 902-904, to specifically perform (or not perform) the transfer based on additional complex conditions. For instance, location-based dynamic recurrence conditions may specify that the transfer should (or should not) be performed at the predetermined recurrence time, if the transferor and/or the transferee are in one or more particular predefined jurisdictions at that time. As an example, a dynamic recurrence condition set in step 803 may cause an instance of a recurring transfer not to be initiated if the transferor is determined to be a particular country at the designated recurrence time. In other examples, dynamic recurrence conditions may be defined relating to transfer fees, exchange rates, and any other potentially fluctuating terms and conditions associated with the transfer. For instance, a dynamic recurrence condition set in step 803 may cause an instance of a recurring transfer not to be initiated if a fluctuating transfer fee at the designated recurrence time exceeds a particular amount (e.g., percentage or total amount). As yet another example, a dynamic recurrence condition set in step 803 may cause an instance of a recurring transfer not to be initiated if a fluctuating currency exchange rate for the transfer exceeds (or falls below) one or more particular exchange rate thresholds at the designated recurrence time.

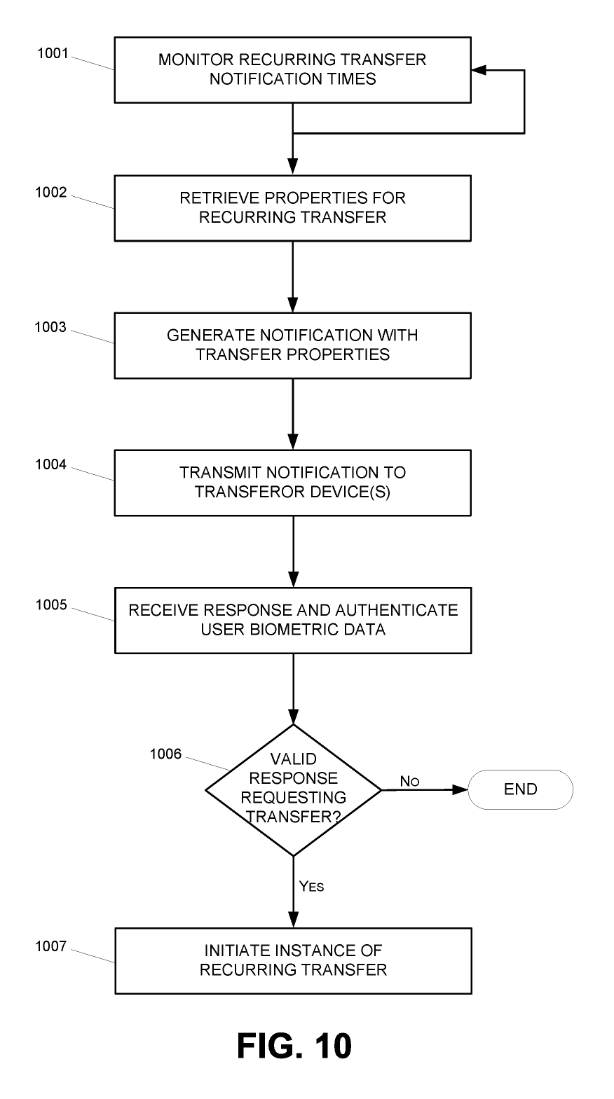

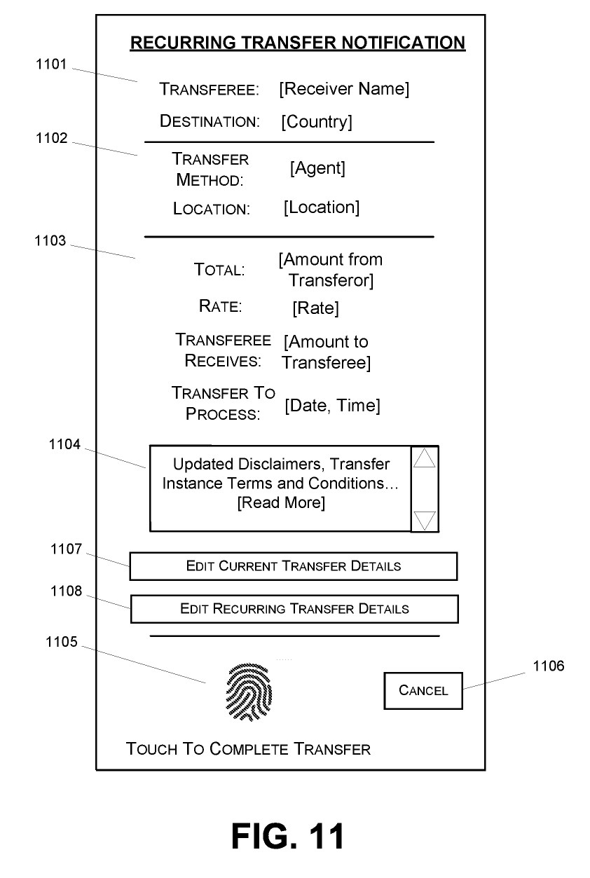

In step 804, the secure transfer system 710 may save both the various transfer properties of the transfer request received and processed in step 801, and the associated recurrence parameters received in step 803. As discussed below in reference to FIGS. 10 and 11, the combination of the transfer properties and associated recurrence parameters may be used to generate and transmit notifications to transferors, automatically initiate and/or stage subsequent transfers (e.g., prepopulating the transfer request fields, etc.), so that so that a user at a transferor device 720 need only confirm his or her identity (e.g., via biometric authentication) and reaffirm that the current instance of recurring transfer is to be performed.

Referring now to FIG. 10, a flow diagram is shown illustrating an example process of transmitting a recurring transfer notification and initiating an instance of a recurring transfer process. As in the examples above, the steps in this process may be performed by one or more components in a transfer system computing environment 700, such as the secure transfer system 710 and transferor device 720 (and/or transferee device 725). However, it should be understood that the various features and processes described herein, including monitoring recurrence parameters, generating and transmitting recurrence notifications, and initiating recurring transfers, need not be limited to the specific systems and hardware implementations described above in FIGS. 1-7.

In step 1001, the secure transfer system 710 may monitor the recurrence schedules and conditions for one or more recurring transfers. For example, in some embodiments the secure transfer system 710 may periodically (e.g., hourly, daily, etc.) invoke an automated process to review all of the saved transfers currently designated for recurrence (e.g., from a recurring transfer data store 713). Certain computing environments 700 may include large numbers of transferors and/or transferees, each of which may setup any number of recurring transfers. Accordingly, the monitoring process in step 1001 potentially may be responsible for monitoring (and then executing) a very large number recurring transfers.

In step 1002, upon determining that a particular recurring transfer is due to be performed based on its scheduling parameters (or at any point prior to the determination), the secure transfer system 710 may retrieve the transfer properties for the particular recurring transfer to be performed. As noted above, transfer properties may include data such as the identity of the transferor (and various transferor-related data fields), the identity of the transferee (and various transferee-related data fields), one or more locations associated with the transfer (e.g., sender and receiver jurisdictions, a pickup location, etc.), one or more amounts associated with the transfer (e.g., monetary amounts to be provided by the transferor and/or provided to the transferee), and/or any other properties of the recurring transfer (e.g., particular transfer delivery conditions, identification of funding sources, rules related to delivery times, locations, etc.).

In step 1003, at a time generally corresponding to the determined time that the recurring transfer is due to be performed based on its scheduling parameters, or prior to the determined time in some embodiments, the secure transfer system 710 may generate a notification to be transmitted to the potential transferor of the recurring transfer. In some embodiments, the notification generated in step 1003 may include some or all of the transfer properties retrieved in step 1002, such as the various transferor and transferee information, transfer location data, transfer amount data, etc., which may be constant across all instances of the recurring transfer.

Additionally, as part of the generation of the recurring transfer notification in step 1003, the secure transfer system 710 may be configured to retrieve and/update transfer data that may change between different instances of the recurring transfer. For example, if a recurring transfer is defined between a particular transferor, particular transferee, for a particular amount, then these values may be constant for each instance of the recurring transfer. However, other data fields relevant to the recurring transfer may change from instance to instance when performing the recurring transfer. For example, the current locations (e.g., jurisdictions) of the transferor and transferee, the current devices of the transferor and transferee, any additional/updated legal regulations, terms, or conditions applicable to the current instance recurring transfer, an applicable exchange rate for the monetary/currency transfer, the applicable fees for the transfer, and various other relevant data, may change between instances of the recurring transfer. Thus, the secure transfer system 710 may determine the current data applicable to the recurring transfer, and may include the data within the notification generated in step 1003.

For example, referring briefly to FIG. 11, an example user interface display screen is shown for a recurring transfer notification. The data included within the notification in this example includes both static transfer data that will not change from one instance to another of the recurring transfer (e.g., fields 1101 and 1102), as well as dynamic transfer data (e.g., field 1103) that may be retrieved/updated by the secure transfer system 710 each time that the recurring transfer is performed.

Further, in some examples, the transferor may be required to expressly review and agree to certain notification data before the transfer may be performed, such as updated regulations, terms and conditions associated with the transfer, etc. Thus, such disclaimers, terms and conditions, regulations, etc., may be included within the notification generated in step 1003, along with a confirmation component (e.g., a checkbox, etc.) to allow the user to confirm assent to the updated regulations, terms and conditions , etc. For instance, in the user interface display screen in FIG. 11, box 1104 may represent an updated set of regulations, legal disclaimers, terms and conditions, and the like, specifically generated for performing this instance of the recurring transactions. Thus, the information in box 1104 may be based on a determination that the transferor is in a new location (e.g., new country or other jurisdiction), a determination the relevant transfer regulations have changed, that the applicable fees and/or exchange rates have changed, that a risk profile of the transferor and/or transferee has changed, etc.

In step 1004, the notification generated by the secure transfer system 710 in step 1003, may be transmitted to one or more transferor device(s) 720 associated with the transferor of the recurring transfer. The notification may be transmitted via any available notification media, including an email, SMS message, instant messenger communication, and/or mobile device push notification. In some cases, the initially notification in step 1004 may contain some or all of the notification data generated in step 1003. However, in other cases, the initial notification transmitted in step 1004 might only contain a link (e.g., a URL, mobile application push notification , etc.) that the user may select to navigate to a web page, invoke a mobile application, etc., where the remaining portions of the notification data generated in step 1003 may be presented.

In some embodiments, the transmission of the notification in step 1004 may include identifying one or more particular the transferor device(s) 720 associated with the transferor. For instance, if the transferor that initially created the recurring transfer has multiple associated user devices (e.g., desktop computers, laptop computers, mobile devices, vehicle-based devices, wearable devices, etc.), then the secure transfer system 710 may determine in step 1004 to which transferor device or devices 720 the notification should be sent. In some cases, the notification may be sent to the device 720 most recently used by the transferor to access the secure transfer system 710. In other cases, the notification may be sent to a preferred transferor device 720, such as the user's smartphone or other mobile device most likely to be in the user's possession at the time of the notification. In still other cases, the notification may be sent to multiple transferor devices 720 associated with the user. Further, particular type of notification transmitted in step 1004 may depend on the transferor device 720 selected for receiving the notification. For example, the transferor's laptop computer 720 may have different notification features and capabilities than the transferor's mobile phone 720 or smartwatch 720, etc.

Additionally, as noted above, the notification transmitted in step 1004 may include one or more user authentication components, such as various biometric input components. Such user authentication components may be required in some embodiments, because the notification may be presented via the transferor's device 720 at a time/location when the transferor has not logged into the secure transfer system 710 or other provided authentication data to verify the transferor's identity. Thus, a push notification transmitted to a mobile device 720, or a pop-up notification displayed on the user's laptop 720, may include an authentication component requiring the user to provide login credentials and/or biometric input data prior to viewing the full contents of the notification or confirming that the recurring transfer should be performed.

Different transferor devices 720 also may be equipped with different specialized authentication hardware and/or software components. For instance, a first transferor device 720 may include a fingerprint sensor, while a second transferor device 720 associated with the same user might include a microphone and voice verification software. Accordingly, in some embodiments, the secure transfer system 710 may maintain multiple types of biometric authentication data for a single user (e.g., a retinal scan, voiceprint, fingerprint, signature, etc.), in order to provide compatibility for multiple different types of transferor device 720. In other cases, the secure transfer system 710 may route notifications specifically to particular devices 720 based on the type(s) of biometric input supported on the device 720. In still other cases, the secure transfer system 710 may instruct the transferor device 720 to require authentication of the user before viewing and/or acting on the notification in step 1004, and then may trust the transferor device 720 to verify the user's identity.

In step 1005, the secure transfer system 710 may receive a user response and/or user authentication data from the transferor device 720, in response to the notification transmitted in step 1004. Then, in step 1006, the secure transfer system 710 may analyze the response received from the transferor device 720, and may determine whether or not to initiate the recurring transfer based on the response. As noted above, in some cases the secure transfer system 710 may directly receive and validate one or more pieces of biometric metric in order to verify the user's identity, while in other cases the secure transfer system 710 may allow a trusted transferor device 720 to handle the user authentication process. In addition to confirming the identity of the transferor, the response received in step 1005 may confirm that the transferor would like to perform the recurring transfer. In some cases, the notification may be configured so that only a single action or input by the user may serve both the purpose of verifying the transferor's identify and confirming that the transferor would like to perform the recurring transfer. For example, referring again to FIG. 11, the user receiving this notification may simply provide their fingerprint at the designated location 1105 to verify their identity and execute the recurring transfer. On the other hand, the user may select the cancel button 1106 to skip this instance of the recurring transfer. Although user authentication and/or biometric input are not required for the cancel option 1106 in this case, such user authentication techniques also may be required to opt-out of a recurring transfer in some embodiments.

Additionally, the response in step 1005 may include one or more edits to the existing properties of the recurring transfer. Such edits may be input by the transferor, via the notification and/or subsequent user interfaces presented on the transferor device in step 1004. For example, referring again to FIG. 11, two additional options 1107 and 110 are presented within the notification to allow the user to edit one or more properties of the current instance of the recurring transfer (1107), or to allow the user to edit one or more properties of the recurring transfer, thereby permanently affecting the subsequent recurring transfers (1108). Upon selection of either edit button 1107 or 1108, the data fields of the transfer notification (e.g., 1101-1103) may become editable but may remain populated, to allow the transferor to update one or more of the transfer properties, either for the current single instance of the recurring transaction, or for all future instances of the recurring transaction.

Finally, in step 1007, if the transferor has responded to the notification with a validated confirmation that the recurring transaction is to be performed (1006: Yes), then the secure transfer system 710 may initiate a process (e.g., within transfer system 711) to perform a transfer using the retrieved properties of the recurring transfer, and/or any additions or revisions to the recurring transfer determined in steps 1002-1006.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

1. A secure transfer system comprising:
a first transferor device comprising:
a processing unit comprising one or more processors;
an input/output (I/O) subsystem configured to receive input data via one or more input devices connected to or integral with the first transferor device;
one or more biometric input devices configured to receive user biometric data; and
memory coupled with and readable by the processing unit and storing therein a set of instructions which, when executed by the processing unit, causes the first transferor device to:
transmit requests to initiate secure transfers, to one or more secure transfer servers;
output, using the I/O subsystem, notifications received from the one or more secure transfer servers and associated with secure transfer requests;
invoke the one or more biometric input devices, in response to receiving notifications associated with secure transfer requests; and
transmit user biometric data received via the one or more biometric input devices, to the one or more secure transfer servers; and
a secure transfer server, wherein the secure transfer server comprises:
a processing unit comprising one or more processors; and
memory coupled with and readable by the processing unit and storing therein a set of instructions which, when executed by the processing unit, causes the secure transfer server to:
receive and store a plurality of properties associated with a first secure transfer request initiated by a first user of the first transferor device;
receive and store one or more recurrence parameters associated with the first secure transfer request;
determine a future recurrence notification time based on the one or more recurrence parameters;
retrieve the plurality of properties associated with the first secure transfer request;
generate a notification including the plurality of properties associated with the first secure transfer request, wherein the notification is customized based on the first transferor device, and wherein the notification includes a data object configured to invoke a process within the secure transfer server to initiate secure transfers;
transmit the notification to the first transferor device, at a time corresponding to the future recurrence notification time;
receive, from the first transferor device and via the data object, a request to initiate a second secure transfer; and
initiate a secure transfer in response to the second secure transfer request, by executing the process within the secure transfer server to initiate secure transfers, and providing as input to the process the retrieved plurality of properties associated with the first secure transfer request.

2. The secure transfer system of claim 1, the memory of the secure transfer server storing therein further instructions which, when executed by the processing unit, causes the secure transfer server to:
in response to the request to initiate the second secure transfer request, determine that updated property values exist for at least one of the retrieved plurality of properties associated with the first secure transfer request;
transmit the updated property values to the first transferor device; and
receive, from the first transferor device, confirmation of the updated property values, prior to initiating the secure transfer in response to the second secure transfer request.

3. The secure transfer system of claim 2, wherein determining that updated property values exist for at least one of the retrieved plurality of properties associated with the first secure transfer request comprises:
determining a first jurisdiction associated with the first secure transfer request;
identifying a physical location of the first transferor device at a time corresponding to the second secure transfer request; and
determining a second jurisdiction associated with the second secure transfer request, based on the physical location of the first transferor device at the time corresponding to the second secure transfer request, wherein the second jurisdiction is different from the first jurisdiction.

4. The secure transfer system of claim 2, wherein the at least one retrieved property for which updated property values exist include one or more of:
a transfer fee associated with the second secure transfer request;
a value exchange rate associated with the second secure transfer request; or
a jurisdiction-based transfer regulation associated with the second secure transfer request.

5. The secure transfer system of claim 1, the memory of the secure transfer server storing therein further instructions which, when executed by the processing unit, causes the secure transfer server to:
transmit, to the first transferor device, a confirmation interface for the second secure transfer request, the confirmation interface including a biometric data input component configured to collect and transmit user biometric data from the first transferor device back to the secure transfer server;
receive, from the first transferor device, a response to the confirmation interface for the second secure transfer request, the response including first user biometric data;
validate the first user biometric data, based on previously stored user biometric data associated with the first secure transfer request; and
complete the secure transfer in response to validating the first user biometric data.

6. The secure transfer system of claim 5, wherein the first user biometric data received from the first transferor device in response to the confirmation interface for the second secure transfer request comprises one or more of:
a user voice sample recorded by first transferor device;
a fingerprint captured by first transferor device; or
a retinal scan captured by first transferor device.

7. The secure transfer system of claim 5, the memory of the secure transfer server storing therein further instructions which, when executed by the processing unit, causes the secure transfer server to:
receive, from the first transferor device via the confirmation interface, one or more updated property values corresponding to one or more of the retrieved plurality of properties associated with the first secure transfer request;
perform the secure transfer using the one or more updated property values; and
overwrite the one or more of the retrieved plurality of properties associated with the first secure transfer request, with the one or more updated property values.

8. The secure transfer system of claim 1, the memory of the secure transfer server storing therein further instructions which, when executed by the processing unit, causes the secure transfer server to:
identify, for the first user associated with the secure transfer request, a plurality of client devices associated with the first user including the first transferor device; and
identify the first transferor device as a current active device of the first user, in response to a determination that a current time corresponds to the future recurrence notification time.

9. The secure transfer system of claim 1, wherein a first property of the retrieved plurality of properties associated with the first secure transfer request comprises one of:
a fixed transfer amount to be received by a transferee at time intervals based on the recurrence parameters; or
a fixed transfer amount to be received from a transferor at time intervals based on the recurrence parameters.

10. A method comprising:
receiving and storing, by a secure transfer server, a plurality of properties associated with a first secure transfer request initiated by a first user of a first transferor device;
receiving and storing, by the secure transfer server, one or more recurrence parameters associated with the first secure transfer request;
determining, by the secure transfer server, a future recurrence notification time based on the one or more recurrence parameters;
retrieving, by the secure transfer server, the plurality of properties associated with the first secure transfer request;
generating, by the secure transfer server, a notification including the plurality of properties associated with the first secure transfer request, wherein the notification is customized based on the first transferor device, and wherein the notification includes a data object configured to invoke a process within the secure transfer server to initiate secure transfers;
transmitting, by the secure transfer server, the notification to the first transferor device, at a time corresponding to the future recurrence notification time;
receiving, by the secure transfer server, from the first transferor device and via the data object, a request to initiate a second secure transfer; and
initiating, by the secure transfer server, a secure transfer in response to the request to initiate the second secure transfer, by executing the process within the secure transfer server to initiate secure transfers, and providing as input to the process the retrieved plurality of properties associated with the first secure transfer request.

11. The method of claim 10, further comprising:
in response to the request to initiate the second secure transfer request, determining that updated property values exist for at least one of the retrieved plurality of properties associated with the first secure transfer request;
transmitting the updated property values to the first transferor device; and
receiving, from the first transferor device, confirmation of the updated property values, prior to initiating the secure transfer in response to the second secure transfer request.

12. The method of claim 11, wherein determining that updated property values exist for at least one of the retrieved plurality of properties associated with the first secure transfer request comprises:
determining a first jurisdiction associated with the first secure transfer request;
identifying a physical location of the first transferor device at a time corresponding to the second secure transfer request; and
determining a second jurisdiction associated with the second secure transfer request, based on the physical location of the first transferor device at the time corresponding to the second secure transfer request, wherein the second jurisdiction is different from the first jurisdiction.

13. The method of claim 11, wherein the at least one retrieved property for which updated property values exist include one or more of:
a transfer fee associated with the second secure transfer request;
a value exchange rate associated with the second secure transfer request; or
a jurisdiction-based transfer regulation associated with the second secure transfer request.

14. The method of claim 10, further comprising:
transmitting, to the first transferor device, a confirmation interface for the second secure transfer request, the confirmation interface including a biometric data input component configured to collect and transmit user biometric data from the first transferor device back to the secure transfer server;
receiving, from the first transferor device, a response to the confirmation interface for the second secure transfer request, the response including first user biometric data;
validating the first user biometric data, based on previously stored user biometric data associated with the first secure transfer request; and
completing the secure transfer in response to validating the first user biometric data.

15. The method of claim 14, wherein the first user biometric data received from the first transferor device in response to the confirmation interface for the second secure transfer request comprises one or more of:
a user voice sample recorded by first transferor device;
a fingerprint captured by first transferor device; or
a retinal scan captured by first transferor device.

16. A non-transitory computer readable medium storing computer-executable instructions that are executable by one or more processors, the computer-executable instructions comprising:
receiving and storing a plurality of properties associated with a first secure transfer request initiated by a first user of a first transferor device;
receiving and storing one or more recurrence parameters associated with the first secure transfer request;
determining a future recurrence notification time based on the one or more recurrence parameters;
retrieving the plurality of properties associated with the first secure transfer request;
generating, by the secure transfer server, a notification including the plurality of properties associated with the first secure transfer request, wherein the notification is customized based on the first transferor device, and wherein the notification includes a data object configured to invoke a process within the secure transfer server to initiate secure transfers;
transmitting, by the secure transfer server, the notification to the first transferor device, at a time corresponding to the future recurrence notification time;
receiving, by the secure transfer server, from the first transferor device and via the data object, a request to initiate a second secure transfer; and
initiating, by the secure transfer server, a secure transfer in response to the request to initiate the second secure transfer, by executing the process within the secure transfer server to initiate secure transfers, and providing as input to the process the retrieved plurality of properties associated with the first secure transfer request.

17. The non-transitory computer readable medium of claim 16, the computer-executable instructions further comprising:
in response to the request to initiate the second secure transfer request, determining that updated property values exist for at least one of the retrieved plurality of properties associated with the first secure transfer request;
transmitting the updated property values to the first transferor device; and
receiving, from the first transferor device, confirmation of the updated property values, prior to initiating the secure transfer in response to the second secure transfer request.

18. The non-transitory computer readable medium of claim 17, wherein determining that updated property values exist for at least one of the retrieved plurality of properties associated with the first secure transfer request comprises:
determining a first jurisdiction associated with the first secure transfer request;
identifying a physical location of the first transferor device at a time corresponding to the second secure transfer request; and
determining a second jurisdiction associated with the second secure transfer request, based on the physical location of the first transferor device at the time corresponding to the second secure transfer request, wherein the second jurisdiction is different from the first jurisdiction.

19. The non-transitory computer readable medium of claim 17, wherein the at least one retrieved property for which updated property values exist include one or more of:
a transfer fee associated with the second secure transfer request;
a value exchange rate associated with the second secure transfer request; or
a jurisdiction-based transfer regulation associated with the second secure transfer request.

20. The non-transitory computer readable medium of claim 16, the computer-executable instructions further comprising:
transmitting, to the first transferor device, a confirmation interface for the second secure transfer request, the confirmation interface including a biometric data input component configured to collect and transmit user biometric data from the first transferor device back to the secure transfer server;
receiving, from the first transferor device, a response to the confirmation interface for the second secure transfer request, the response including first user biometric data;
validating the first user biometric data, based on previously stored user biometric data associated with the first secure transfer request; and
completing the secure transfer in response to validating the first user biometric data.
